(19) United States
(12) Patent Application Publication
(10) Pub. No.: US 2026/0100880 A1
(43) Pub. Date: Apr. 9, 2026

(54) NETWORK ADJUSTMENT BASED ON MACHINE LEARNING END SYSTEM PERFORMANCE MONITORING FEEDBACK

(71) Applicants: Leon Reznik, West Henrietta, NY (US); Sergei Chuprov, West Henrietta, NY (US)

(72) Inventors: Leon Reznik, West Henrietta, NY (US); Sergei Chuprov, West Henrietta, NY (US)

(73) Assignee: Rochester Institute of Technology, Rochester, NY (US)

(21) Appl. No.: 19/112,000

(22) PCT Filed: Sep. 13, 2023
(86) PCT No.: PCT/US23/74057

§ 371 Date: Mar. 14, 2025

Related U.S. Application Data
(60) Provisional application No. 63/406,514, filed on Sep. 14, 2022.

(51) Int. Cl. H04L 41/0823; H04L 41/147; H04L 41/16

(52) U.S. Cl. CPC H04L 41/0823; H04L 41/147; H04L 41/16

(57) ABSTRACT

A system, method, and computer readable storage medium for generating instructions to adjust a network parameter. The system, method, and computer readable storage medium include: i) receiving data transmitted from a data source to a machine learning end-system via a network facility, the data transmission being characterized by a network parameter; ii) making a decision with the machine learning end-system, using the data, iii) determining a decision performance metric for the decision, iv) comparing the decision performance metric to a decision performance specification; and v) generating instructions to adjust the network parameter based on the comparison.

### CROSS-REFERENCE TO RELATED APPLICATIONS

This application claims the benefit of the filing date of U.S. Provisional Patent Application No. 63/406,514, filed Sep. 14, 2022, which is hereby incorporated by reference in its entirety.

### FIELD OF THE DISCLOSURE

The present disclosure generally relates to machine learning systems. More specifically, the present disclosure is directed to methods and systems for improving performance of machine learning end-systems through network adjustments.

### BACKGROUND

Advances in the areas of communication and artificial intelligence (AI) have resulted in the design of integrated systems where computer networks are used to transfer data from remote sensors and internet of things (IoT) devices to cloud-based machine learning (ML) systems. An example of such an integrated system is the ShotSpotter smart street autonomous monitoring system disclosed by Doucette et al. “Impact of ShotSpotter Technology on Firearm Homicides and Arrests Among Large Metropolitan Counties: A Longitudinal Analysis, 1999-2016.” Journal of urban health 98.5 (2021): 609-621. This system transmits data from a network of sound sensors, spread throughout a metropolitan area, to a ML system that uses the data to detect street shootings.

Within these integrated systems, the performance of the end-line ML systems highly depends on the quality of the data that computer networks deliver to them. There are various previously known techniques for improving the quality of the data source, or the produced data itself. One technique is data cleaning, which involves improving the data quality by removing or “repairing” errors, typos, missing values, replicated items, and violations of business rules. Data cleaning may also include tests for removing statistical outliers, and more generally evaluating if the data satisfies statistical requirements. Another technique for improving the data used by an ML system is data filtering, which involves removing noise and other information that only serves to negatively affect the ML data-driven application performance. Yet another technique is data wrangling, which typically refers to raw data iterative exploration and transforming the data into a format acceptable for ML system input. Data wrangling procedures may include data mapping, transforming the data to another format, labeling, hierarchical allocation, and making data comfortable to consume by the targeted tool or application.

All the methods above are focused on the quality of the produced data itself as the primary indicator of ML performance, and they usually do not consider how data utilization further along the pipeline impacts system performance from an integrated perspective. Other approaches concentrate on the ML system itself and try to improve the MP system's robustness to noisy and low-quality data, or focus on fitting pre-trained ML models to data from domains different from those the models were trained in.

Yet another strategy for system improvement includes network-oriented approaches aimed at improving the performance of the network transmission itself. These approaches commonly concentrate only on assessing the network performance and applying the appropriate corrective measures.

Each of these approaches are limited in that they aim to improve the performance of the integrated system by individually assessing the performance of components within the system. Accordingly, there still exists a need in the art for methods and systems that improve the performance of an ML end-system by generating instructions for adjusting network parameters based on decisions made by the ML end-system.

### SUMMARY OF THE DISCLOSURE

The present disclosure is generally related to methods and systems for generating instructions aimed at improving performance of a machine learning end-system by managing network parameters. This includes receiving data transmitted from a data source to a machine learning end-system via a network facility, the data transmission being characterized by a network parameter, making a decision with the machine learning end-system based on the data, determining a decision performance metric for the decision, comparing the decision performance metric to a decision performance specification, and generating instructions to adjust the network parameter based on the comparison.

One manner in which the systems and methods disclosed herein improve upon conventional single component approaches is through the realization that performance of the machine learning end-system is influenced not just by the quality of data source, or the data itself, but also by how that data is handled by other components within the integrated machine learning system pipeline. Accordingly, the disclosed methods and systems can determine a decision performance metric, compare the decision performance metric to a decision performance specification, and generate instructions to adjust a network parameter based on Generally, in one aspect, the disclosure relates to a method for generating an instruction to adjust a network parameter. The method includes receiving data transmitted from a data source to a machine learning end-system via a network facility, the data transmission being characterized by a network parameter. The method further includes making a decision with the machine learning end-system using the data. The method further includes determining a decision performance metric for the decision. The method further includes comparing the decision performance metric to a decision performance specification. The method further includes generating instructions to adjust the network parameter based on the comparison.

In some aspects, the method further includes adjusting the network parameter, with the network facility, based on the generated instruction.

In some aspects, the generated instruction includes an instruction to the network facility to: switch a network protocol, adjust a priority of packets used by the machine learning end-system to make the decision, adjust a network bandwidth, adjust a network buffer size; and/or adjust a network route.

In some embodiments, the network parameter includes a network transport layer protocol and the generated instruction includes an instruction to the network facility to switch the network transport layer protocol from a user datagram protocol (UDP) to a transmission control protocol (TCP).

In some other aspects, the decision performance metric includes: an accuracy of the decision, an error rate of the decision; and/or a true positive rate of the decision.

In some embodiments, the decision performance specification includes a decision performance threshold and the generated instruction includes an instruction for adjusting the network parameter so that the decision performance metric meets or exceeds the decision performance threshold.

In some embodiments the method includes receiving results of a comparison between a quality of service (QOS) metric and a QoS specification, wherein the network facility is configured to determine the QoS metric based on the transmission of data from the data source to the machine learning end-system. In some embodiments the generated instruction is further based on the comparison between the QoS metric and the QoS specification.

In another aspect, the QoS metric includes: a packet loss, a network delay, a network latency, and/or a network jitter.

In some embodiments, the method includes communicating a network threat based on the comparison between the QoS metric and the QoS specification.

In some embodiments, comparing the decision performance metric to the decision performance specification further includes determining a percentage of the decision performance metric relative to the decision performance specification and comparing the QoS metric to the QoS specification further includes determining a percentage of the QoS metric relative to the QoS specification.

In some embodiments, the machine learning end-system is a smart voice assistant, the QoS metric includes a packet loss, and the network parameter includes a network transport layer protocol.

In some embodiments the generated instruction includes a rule-based instruction to the network facility, the rule-based instruction including: switching to a UDP network transport layer protocol when the decision performance metric is 5-6% below of the decision performance specification and the packet loss is less than 2.5% of the QoS specification, switching to a TCP network transport layer protocol when the decision performance metric is between 6-9% below the decision performance specification and the packet loss is between 5-10% greater than the QoS specification, and switching to a QUIC network transport layer protocol when the decision performance metric is 10% or more below the decision performance specification and the packet loss is more than 10% greater than the QoS specification.

In some other aspects, the generated instruction includes an instruction to switch the data source based on the comparison between the QOS metric and the QoS specification.

In yet some other aspects the method includes communicating the generated instruction via a user interface.

In some embodiments, the decision made by the machine learning end-system includes: classifying the data, detecting a pattern in the data, predicting future data based on the transmitted data; and/or recognizing a pattern in the data.

A further aspect of the disclosure relates to a non-transitory computer readable storage medium, the computer readable storage medium having computer readable code embodied therein, the computer readable code being configured such that, on execution by a suitable computer or processor, the computer or processor is caused to perform a method. The method includes receiving data transmitted from a data source to a machine learning end-system via a network facility, the data transmission being characterized by a network parameter. The method further includes making a decision with the machine learning end-system using the data. The method further includes determining a decision performance metric for the decision. The method further includes comparing the decision performance metric to a decision performance specification. The method further includes generating instructions to adjust the network parameter based on the comparison.

Yet a further aspect of the disclosure relates to an integrated machine learning system. The system including a network facility configured to transmit data from a data source to a machine learning end-system, the data transmission being characterized by a network parameter. The system further including the machine learning end-system configured to: i) make a decision using the transmitted data, ii) determine a decision performance metric for the decision, iii) compare the decision performance metric to a decision performance specification; and iv) generate instructions to adjust the network parameter, based on the comparison.

In some embodiments the machine learning end-system is a cloud-based system.

In some embodiments the data source generates the data based on environmental information detected by a sensor.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software, firmware, or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

FIG. 1 is a flow chart illustrating interactions between various components of an integrated machine learning system 100 according to some aspects of the present disclosure;

FIG. 2 is flow chart illustrating operation of a data source according to some aspects of the present disclosure;

FIG. 3 is flow chart illustrating operation of a network facility according to some aspects of the present disclosure;

FIG. 4 is flow chart illustrating operation of a decision maker of a machine learning end-system according to some aspects of the present disclosure;

FIG. 5 is flow chart illustrating operation of a performance evaluator of a machine learning end-system according to some aspects of the present disclosure;

FIG. 6 is flow chart illustrating operation of a network adjustment generator of a machine learning end-system according to some aspects of the present disclosure;

FIG. 7 is a flow chart illustrating instructions being communicated via a user interface according to some aspects of the present disclosure;

FIG. 8 is a flow chart illustrating a method for adjusting a network parameter according to some aspects of the present disclosure; and

FIG. 9 is a flow chart illustrating a system for generating network adjustments using network adjustment rules according to some aspects of the present disclosure.

### DETAILED DESCRIPTION OF EMBODIMENTS

The present disclosure is generally related to methods and systems for generating instructions aimed at improving performance of a machine learning (ML) end-system by managing network parameters. This includes receiving data transmitted from a data source to an ML end-system via a network facility, the data transmission being characterized by a network parameter, making a decision with the ML end-system using the data, determining a decision performance metric for the decision, comparing the decision performance metric to a decision performance specification, and generating instructions to adjust the network parameter based on the comparison.

One manner in which the systems and methods disclosed herein improve upon conventional single component approaches is through the realization that performance of the ML end-system is influenced not just by the quality of data source, or data itself, but also by how that data is handled by other components within the integrated ML system pipeline. Accordingly, the disclosed methods and systems can determine a decision performance metric, compare the decision performance metric to a decision performance specification, and generate instructions to adjust a network parameter based on the comparison.

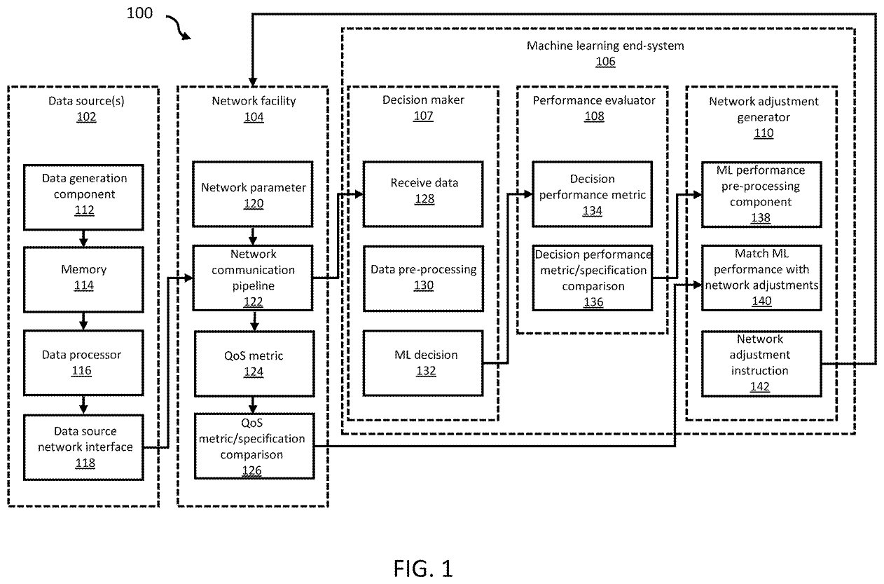

FIG. 1 is a flow chart illustrating interactions between various components of an integrated ML system 100 according to some aspects of the present disclosure. The integrated ML system 100 includes a data source 102, an ML end-system 106, and a network facility 104 configured to transmit data from data source 102 to ML end-system 106. ML end-system 106 is configured to make a decision 132 using the data received from network facility 104. The quality of decision 132 depends not just on the quality of the data transmitted from data source 102, but also on the quality of the transmission process itself. To achieve higher decision-making performance, ML end-system 106 will generally be trained on high quality data. When data is corrupted or distorted during the transmission process, the data distribution stream will differ from that on which the ML end-system 106 was originally trained, leading to decreased performance by ML end-system 106. For example, in the case that ML end-system 106 is an image classifier, degradation in network quality of service (QOS) performance can result in image pixel pattern modifications. Modifications in the image pixel patterns make it harder for an image classifier that was trained on high quality pixel patterns to make accurate decisions.

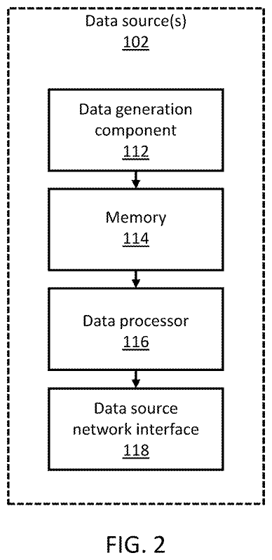

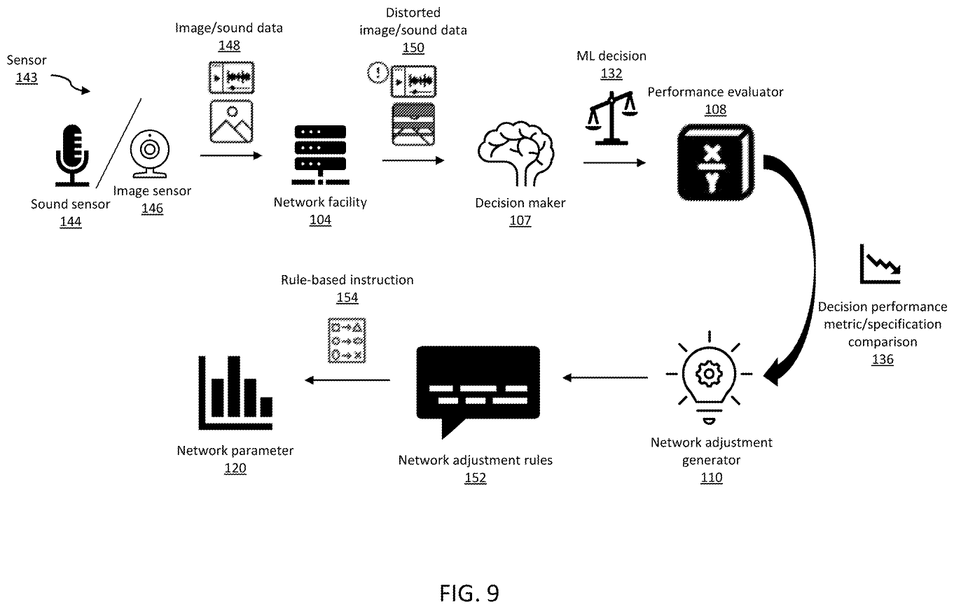

FIG. 2 illustrates operation of data source 102 according to some aspects of the present disclosure. Data source 102 includes a data generation component 112 where data is born or where physical information is first digitized. In some examples, the data source 102 generates the data based on environmental information detected by one or more sensors. For example, with reference to FIG. 9, a sensor 143 could be a sound sensor 144, such as a microphone, or an image sensor 146, such as a camera. Alternatively, data source 102 could be a database from which the data is derived on demand, in which case, sensors would not be required for generating the data. Depending on the particular application, the data source 102 may also include a local memory 114 for storing the collected data prior to transmission. In most practical applications, data source 102 will further include a data processor 116 to prepare the data for transmission, however, the details of this data processing are not important for practicing the techniques of this disclosure. Data source 102 further includes a data source network interface 118 for connecting data source 102 to network facility 104. Data source network interface 118 can be implemented as a hardwired connection, such as ethernet, or a wireless connection such as 3G/4G/5G networks or IEEE 802.11 (WiFi).

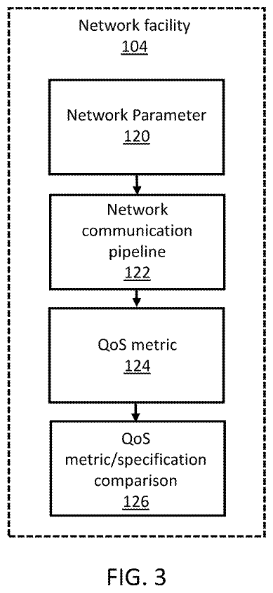

FIG. 3 illustrates operation of network facility 104 according to some aspects of the present disclosure. As previously mentioned, the network facility 104 is configured to transmit data from the data source 102 to ML end-system 106. This transmission of data is characterized by one or more network parameters 120. Network facility 104 may be further configured to generate a QoS metric 126 based on the transmission of data from data source 102 to ML end-system 106. Network parameter 120 may take various forms depending on the network implementation and user needs. Some examples of network parameters include: a network protocol, a priority of data packets, the network bandwidth, a network buffer size, and/or a network route. In some embodiments, network facility 104 is able to adjust network parameters (such as those listed above) to user and/or application requirements “on the fly”. One way that this “on the fly” network parameter adjustment can be achieved is through Software Defined Networking (SDN). In this way, network facility 104 can automatically use instructions generated by a network adjustment generator 110 as feedback for adjusting network parameter 120.

Data is transmitted from data source 102 to ML end-system 106 using a network communication pipeline 122. Network communication pipeline 122 can include a plurality of network stations and network transmission lines, but the exact architecture and components would vary depending on the application of ML end-system 106. Some examples of QoS metric 124 include: packet loss, network delay, network latency, and/or network jitter.

FIG. 3 further shows network facility 104 being further configured to compare QoS metric 124 to a QoS specification. The QoS metric/specification comparison 126 may be based on user input or application specific requirements. For example, packet loss below 1% is generally considered as “good” for most real-time end applications such as voice over internet protocol (VoIP) and video streaming, and loss between 1% and 2.5% may be “acceptable”. On the other hand, higher packet losses, sometimes even up to 100%, can indicate serious problems with network performance. Such high packet losses may be caused by various factors including high network congestion, improper network equipment configuration, or denial-of-service (DOS) attacks. The QoS specification would reflect such application standards to monitor whether the QoS metric is in compliance with such standards.

QoS metric 124 is based on the transmission of data, which is further based on network parameter 120. For example, network parameter 120 could include a network protocol such as CoAP, MQTT, or SMQTT. These protocols are further based on TCP (e.g., MQTT, SMQTT) or UDP (e.g., CoAP, MQTT-SN) on the transport level. Depending on the QoS specification, systems and devices receiving transmitted data via network facility 104 may have one or more limitations related to the power consumption or computational resources. For example, if there is a large IoT network with a requirement to broadcast data to many low-power IoT devices, it might be preferable to use UDP as a transport level protocol, as it demands much less power and computational resources. Moreover, packet loss can occur not only in a communication channel, but also on a receiving node due to filtering and dropping of specific packets. Packet losses may result in consequent transmitted data losses, which can affect an end user experience or performance of an application that perceives or processes this data. Moreover, the use of a UDP as a transport level protocol can result in a packet loss, while TCP can ensure the lost packets retransmission, however, the communication latency increases in this case.

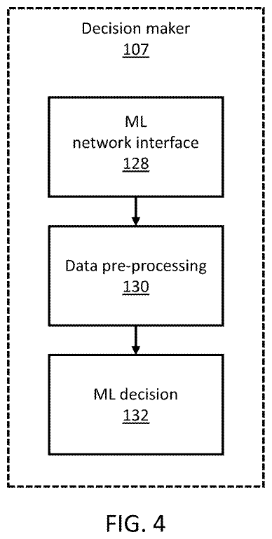

With reference to FIG. 4, ML end-system 106 is configured to receive data from network facility 104 via a network interface 128. Similar, to data source 102, ML end-system 106 serves as another node in the broader data transmission system. ML end-system 106 includes a decision-maker 107. Decision maker 107 optionally includes further data pre-processing 130 in order to reconfigure the transmitted data into a more suitable form for use by decision maker 107. The details of the optional data pre-processing 130 would vary depending on the particular structure and application of ML end-system 106. Decision maker 107 is configured to make a decision 132 using the transmitted data. The decision 132 made by the ML end-system 106 may include: classifying the data, detecting a pattern in the data, predicting future data based on the transmitted data, and/or recognizing a pattern in the data. ML end-system 106 may be based on any ML model previously known in the art, for example deep learning, artificial neural networks, or convolution neural networks. In some embodiments, ML end-system 106 is a cloud-based ML end-system. ML end-system 106 may be trained and further re-trained on data of any type, format, and structure, which are determined by the user and application requirements. Notably, the teachings of this disclosure do not focus on the particular training of ML end-system 106 and are equally applicable to pre-trained ML systems.

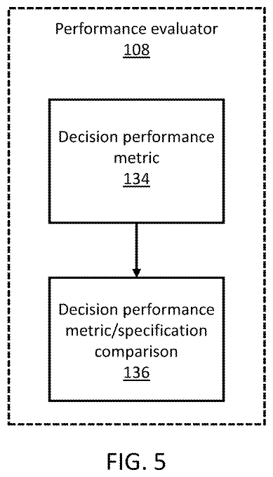

Turning to FIG. 5, ML end-system 106 further includes a performance evaluator 108. Performance evaluator 108 may be internal to decision maker 107, or it may include software and/or hardware components separate from decision maker 107. Performance evaluator 108 determines a decision performance metric 134 for the decision 132 made by decision maker 107. Decision performance metric 134 could include, for example, an accuracy of decision 132 (for example, decision maker 107 could be an image classifier and decision performance metric 134 could be a ratio of correctly classified images over total images classified), an error rate of decision 132, and/or a true positive rate of decision 132. Performance evaluator 108 is further configured to compare decision performance metric 134 to a decision performance specification. This is indicated by the decision performance metric/specification comparison 136 shown in FIG. 5. The decision performance specification may be generated by user input, industrial standards and policies, and/or specification values based on the particular application. The decision performance specification could include a decision performance threshold indicating various levels of decision performance. For example, comparing decision performance metric 134 to the decision performance specification could include determining whether decision performance metric 134 meets or exceeds the decision performance threshold, indicating acceptable decision performance, or falls below the decision performance threshold, indicating unacceptable decision performance.

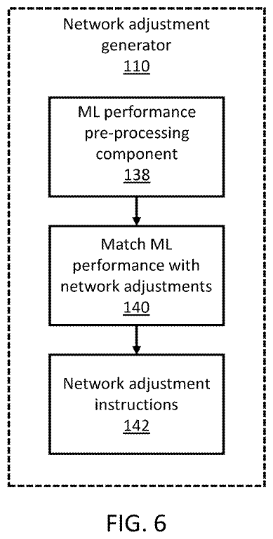

Turning to FIG. 6, ML end-system 106 further includes a network adjustment generator 110. Network adjustment generator 110 is configured to generate instructions to adjust network parameter 120 based on the comparison 136 between the decision performance metric 134 and the decision performance specification. Network adjustment generator 110 may include an additional pre-processing component 138 for reconfiguring the data into a more suitable form for generating the network adjustments. Network adjustment generator 110 matches 140 decision performance, as determined by the comparison 136 between the decision performance metric 134 and the decision performance specification, to network adjustments. For example, in the case that the decision performance specification includes a decision performance threshold, the network adjustment could be generated so that the decision performance metric 134 meets or exceeds the decision performance threshold. For example, this could include generating instructions to network facility 104 to: switch to another network transport protocol, adjust a network route, increase a communication channel bandwidth, adjust the priority of particular data packets used by ML end-system 106, and/or change a buffer size.

Network adjustment generator 110, as illustrated back in FIG. 1, further receives results of comparison 124 between QoS metric 124 and the QoS specification. In this case, network adjustment instructions 142 could further be based on the comparison 124 between QOS metric 124 and the QoS specification. For example, when network adjustment generator 110 determines that the decision performance metric 134 fails to meet the decision performance specification and further determines that the network latency is greater than specified by the QoS specification, then the network adjustment generator 110 could generate instructions to change the network route to increase decision performance by decreasing network latency.

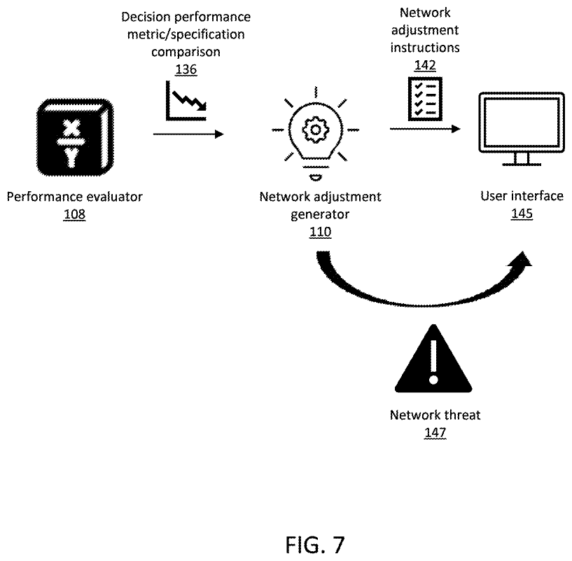

With reference to FIG. 7, instead of generating instructions to network facility 104, network adjustment generator 110 could generate instructions 142 to a network administrator in the form of a network adjustment recommendation. The network administrator could then decide whether to implement the instructions 142 herself, or decide whether to pass the instructions along to network facility 104 to make the adjustment. Such a recommendation could include any of the previously mentioned examples of network adjustments. Instructions to a network administrator could be communicated via a user interface 145. User interface 145 includes any previously known method of communicating instructions to a network administrator such as a computer screen or speakers.

Network adjustment generator could communicate information to a user in addition to the network adjustment instructions 142. For example, network adjustment generator 110 could communicate a network threat 147 based on the comparison between the QoS metric 124 and the QoS specification. Conventional network attacks have a known effect on network performance. For example, a DoS network attack can be recognized based on monitoring which network protocols are used and how frequently the connection requests are initiated, which hosts create these requests, etc. These network attacks usually lead to a deterioration of network QoS. The interrelations between the attacks and the knowledge of the particular QOS metric degradation could allow ML end-system 106 to establish the patterns for network attack detection.

Network adjustment instructions 110 could further include instructions to network facility 104 to switch data source 102 based on the comparison between the QoS metric 124 and the QoS specification. In this way, integrated ML system 100 provides for yet another way for compensating for decreased network performance by switching to a more robust data source. Instead of just considering the impact of a low-quality data source on decision performance metric 134, network adjustment generator 110 considers the impact of data source 102 on both decision performance metric 134 and QoS metric 124 from an integrated system perspective. In some cases it is possible that data produced at data source is not of such low quality that it would significantly degrade the performance of ML end-system 106, however, the data source may still be problematic from the viewpoint of slowing down network transmission, thereby indirectly impacting decision performance metric 134.

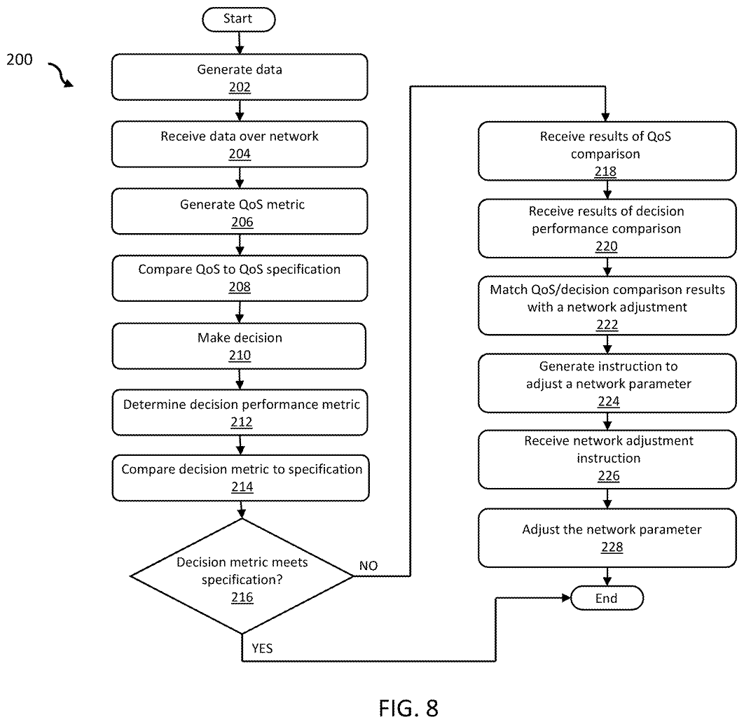

FIG. 8 is a flowchart illustrating a method 200 for adjusting a network parameter based on a decision made by a ML end-system. Step 202 includes generating data. This step can be performed, for example, using previously discussed data source 102. Step 204 includes receiving data over a network. For example, this step could be performed by network facility 104 transmitting data from data source 102 to ML end-system 106. Step 206 includes generating a QOS metric. This step could be performed by the techniques previously discussed with reference to network facility 104. At step 208, method 200 compares the QoS metric to a QoS specification. This step similarly could be performed by the techniques previously discussed with reference to network facility 104. Step 210 of method 200 involves making a decision. This step could be performed by the decision maker 107 of ML end-system 106 using transmitted data to make a decision such as classifying the data, detecting a pattern in the data, predicting future data based on the transmitted data, and/or recognizing a pattern in the data. At step 212, method 200 determines a decision performance metric for the decision. This step may be performed by performance evaluator 108 using previously discussed techniques. Step 214 includes comparing the decision performance metric to a decision performance specification. This comparison may be based on ensuring that the decision meets user requirements or application specific criteria for performance. In this case, at step 216, method 200 determines whether the decision performance metric meets the decision performance specification. If the decision performance metric does meet the decision performance specification, then method 200 may determine that there is no need for generating network adjustment instructions based on this decision.

Steps 218 and 220, include receiving the respective results of the network performance comparison between the QoS metric and QoS specification, and decision performance comparison between the decision performance metric and the decision performance specification. These receiving steps may be performed by the previously discussed network adjustment generator 110. The network adjustment generator 110 may be separate from or integrated with the performance evaluator 108 and/or decision maker 107 without deviating from the techniques of this disclosure. At step 224, method 200 generates instructions to adjust a network parameter based on the comparison between the decision performance metric and the decision performance specification, and further based on the comparison between the QOS metric and the QoS specification. For example, as shown at step 222, this could include matching the appropriate network adjustment with information about decision and network performance determined from the two comparisons. At step 226, the network adjustment instructions are received, for example by network facility 104. In the case that network facility 104 has the capacity to adjust its own network parameters, such as when network facility 104 is implemented as an SDN, network facility 104 may implement step 228 of adjusting the network parameter. In other cases, the network could be controlled by a separate system administrator that receives the instructions and decides for herself whether to perform the network adjustment.

The techniques disclosed herein account for how the components of integrated data, network, and ML systems interact on the system level, and how these interactions influence ML decision performance. These techniques use the end application performance as an indicator to recommend network adjustment actions. The recommended network adjustment actions are concentrated not only on the network performance itself but also on assuring ML decision performance is maintained at an acceptable level, as specified by the user and application requirements.

This approach helps to address the problem of ML decision performance degradation due to network performance deterioration. The systems and methods herein generate instructions for network adjustment actions to maintain ML decision performance despite network performance degradation. The techniques disclosed herein can be applied to a wide range of integrated ML systems such as: voice recognition and transcription, sound classification, predictive AI, and image classification. The following examples illustrate how the disclosed systems and methods can maintain ML decision performance by generating network adjustment recommendations. These examples, however, are by no means intended to be the only examples or applications of the disclosed embodiment.

### Example 1: Smart Assistant Voice Recognition

With reference to FIG. 9, ML end-system 106 of Example 1 is a real-time smart voice assistant that helps users perform actions over a call. For example, the smart assistant could communicate call options to a user, receive requests, or direct the call so that the user could talk with an appropriate specialist. The smart voice assistant receives data from a sound sensor 144 used to capture the user's voice. The users' voice is transferred as sound data 148 as a VoIP over a network facility 104, which may consist of various nodes and transmission devices, and may further provide different network routes. All these network nodes and other transmission devices can be characterized as the network facility 104.

VoIP usually employs UDP as a network transport protocol, which allows faster data transmission in contrast to TCP. TCP traffic needs to undergo some connection establishing procedures, such as synchronization and acknowledgement (known as SYN, SYN-ACK, ACK). If the number of nodes communicating within the network is high, the voice transmission using TCP on the transport level becomes inefficient in terms of resources and can create intolerable latency. Using UDP for real-time voice transmission is significantly more efficient in terms of required network resources and data transmission rate. However, UDP is less reliable and cannot handle network packet losses resulting in distorted data 150 deteriorating the end user's Quality of Experience (QoE). In other words, when the packet loss ratio exceeds some threshold, the communication network QoS becomes unacceptable for providing users with high quality calls. This QoS network degradation not only affects the human end user's experience, but can also affect the performance of a ML end-system 106, such as the voice assistant, receiving data from the network. The performance of the voice assistant's decision 132 may be evaluated by the means of the assistant itself, based on the user feedback, or by a separate performance evaluating device. For instance, decision performance metric 134 may be determined based on the correct actions, that the ML end system 106 performs according to the recognized and transcribed voice commands from the user. If ML end system's 106 performance drops below the specified level, network adjustment generator 110 is triggered to generate instructions aimed at increasing decision performance. The network adjustment instructions may be rule-based instructions 154 for adjusting one or more network parameter 120 based on network adjustment rules 152.

An example of such rule-based instructions 154 include:
if decision performance metric 134 is 5-6% below the decision performance threshold and packet loss is less than 2.5% greater than a packet loss threshold: use a UDP network transport protocol to transmit data.
if decision performance metric 134 is 6-9% below the decision performance threshold, packet loss is between 5-10% above of the packet loss threshold, and delay meets or exceeds a delay threshold: use a TCP network transport protocol to transmit data.
if decision performance metric 134 drops to more than 10% below the decision performance threshold and either one of: packet loss is more than 10% greater than the packet loss threshold or delay is below the delay threshold: use a QUIC network transport protocol to transmit data. Note that a high decision performance metric relative to the decision performance threshold is generally desired, while a low packet loss relative to the packet loss threshold is desired.

### Example 2: Sound Transmission in IoT Networks

Often IoT devices are equipped with a sound sensor 144, such as a microphone, and are able to transmit the captured sounds to a remote server or other IoT devices. In some cases, the processing of the captured sound can take place on the IoT device. However, this may require computational resources that are too prodigal for small IoT devices. An example of such an application is ShotSpotter system, that is employed in many US cities. This system uses data from sound sensors 144 to detect gun shootings and direct law enforcement to their approximate location.

The network protocols employed to broadcast media files over IoT networks, typically use UDP or TCP on the transport level. In some IoT network configurations, it might be necessary to broadcast data from one IoT device to many others. In this case, either UDP or TCP transport protocols can be used. However, the use of TCP is more resource constraint, as it requires both establishing the connection and then verifying that the transmitted data has been received. This increased resource consumption may not be feasible for low-power IoT devices, and can lead to device failure or increased network delay. In addition, the use of TCP decreases the data transmission rate in comparison to UDP, which may not be tolerable for most practical applications in real-time systems.

In Example 2, transmitted sound data from a sound sensor 144 is converted in image data, to which an industrial image classifier is configured to assign the proper labels. Decision performance metric 134 may be based on an accuracy of the labels determined by the image classifier. The ruled-based instructions for Example 2 include:
if accuracy is 5% or less below the accuracy threshold and packet loss is less than 10% greater than a packet loss threshold: use UDP network transport protocol to transmit data.
if accuracy is 6-9% below the accuracy threshold, packet loss is between 11-20% greater than the QOS specification, and delay meets or exceeds a delay threshold: use TCP network transport protocol to transmit data.
if accuracy drops to more than 10% below the accuracy threshold and either one of: packet loss is 21% or more greater than the packet loss threshold or delay is below the delay threshold: use QUIC network transport protocol to transmit data.

### Example 3: Infotainment Communication in VANETs

Originally, vehicle ad hoc networks (VANETs) emerged to introduce additional safety and security features into the intelligent transportation system concept. However, with the evolution in communication and transportation areas, such networks have been adapted to provide vehicle users with various infotainment features. An example of these features can be broadcasting of the information on the current road conditions, including online images and video streaming. VANETs are known for their dynamic nature, as nodes can travel with a high speed. In this case, it is important to find a trade-off between the quality of transmitted data, and the network reliability. The use of UDP on the network transport layer can provide the required data transmission rate, however, the overall quality of transmitted data may be affected.

High packet losses can significantly affect the quality of transmitted data, and consequently the performance of ML end-system 106. Example 3 is based on the interrelationship between the network packet loss and the performance of several pre-trained industrial image classifiers. The employed industrial image classifiers differentiate transmitted image data 148 between two categories: stop sign or traffic sign. Network adjustment rules 152 may be established based on the results of empirical investigation. The decision performance metric 134 may be based on the accuracy of the image classifier at differentiating the images. The network adjustment rules 152 for Example 3 include:
if accuracy is 7% or less below an accuracy threshold and packet loss is less than 1% greater than a packet loss threshold: use UDP network transport protocol to transmit data.
if accuracy is between 8-14% below the accuracy threshold and packet loss is between 2-5% greater than the packet loss threshold and delay meets or exceeds a delay threshold): use TCP network transport protocol to transmit data.
if accuracy drops by more than 15% below the accuracy threshold and either one of: packet loss is more than 6% above the packet loss threshold or delay is below the delay threshold): use QUIC network transport protocol to transmit data.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software, or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed is:

1. A method (200) for generating an instruction to adjust a network parameter (120), the method comprising:
receiving (204) data transmitted from a data source (102) to a machine learning end-system (106) via a network facility (104), the data transmission being characterized by a network parameter (120);
making (210) a decision with the machine learning end-system (106) using the data;
determining (212) a decision performance metric (134) for the decision;
comparing (214) the decision performance metric (134) to a decision performance specification; and
generating (224) an instruction to adjust the network parameter (120) based on the comparison.

2. The method (200) of claim 1, further comprising:
adjusting (228) the network parameter (120), with the network facility (104), based on the generated instruction.

3. The method (200) of claim 1, wherein the generated instruction comprises an instruction to the network facility (104) to:
switch a network protocol;
adjust a priority of packets used by the machine learning end-system (106) to make the decision;
adjust a network bandwidth;
adjust a network buffer size; and/or
adjust a network route.

4. The method (200) of claim 1, wherein the network parameter (120) comprises a network transport layer protocol and wherein the generated instruction comprises an instruction to the network facility (104) to switch the network transport layer protocol from a user datagram protocol (UDP) to a transmission control protocol (TCP).

5. The method (200) of claim 1, wherein the decision performance metric (134) comprises:
an accuracy of the decision;
an error rate of the decision; and/or
a true positive rate of the decision.

6. The method (200) of claim 1, wherein the decision performance specification comprises a decision performance threshold and the generated instruction comprises an instruction for adjusting the network parameter (120) so that the decision performance metric (134) meets or exceeds the decision performance threshold.

7. The method (200) of claim 1, further comprising:
receiving (220) results of a comparison between a quality of service (QOS) metric (124) and a QoS specification, wherein the network facility (104) is configured to determine the QoS metric (124) based on the transmission of data from the data source (102) to the machine learning end-system (106); and
wherein the generated instruction is further based on the comparison between the QoS metric (124) and the QoS specification.

8. The method (200) of claim 7, wherein the QoS metric (124) comprises:
a packet loss;
a network delay;
a network latency; and/or
a network jitter.

9. The method (200) of claim 7 further comprising communicating a network threat (147) based on the comparison between the QoS metric (124) and the QoS specification.

10. The method (200) of claim 7 wherein comparing (214) the decision performance metric (134) to the decision performance specification further comprises determining a percentage of the decision performance metric (134) relative to the decision performance specification and comparing (208) the QoS metric (124) to the QoS specification further comprises determining a percentage of the QoS metric (124) relative to the QoS specification.

11. The method (200) of claim 10, wherein the machine learning end-system (106) is a smart voice assistant, the QoS metric (134) comprises a packet loss, and the network parameter (120) comprises a network transport layer protocol.

12. The method (200) of claim 11, wherein the generated instruction comprises a rule-based instruction (154) to the network facility (104), the rule-based instruction (154) comprising:
switching to a UDP network transport layer protocol when the decision performance metric (134) is 5-6% below of the decision performance specification and the packet loss is less than 2.5% of the QoS specification;
switching to a TCP network transport layer protocol when the decision performance metric (134) is between 6-9% below the decision performance specification and the packet loss is between 5-10% greater than the QoS specification; and
switching to a QUIC network transport layer protocol when the decision performance metric (134) is 10% or more below the decision performance specification and the packet loss is more than 10% greater than the QoS specification.

13. The method (200) of claim 7 wherein the generated instruction comprises an instruction to switch the data source (102) based on the comparison between the QoS metric (124) and the QoS specification.

14. The method (200) of claim 1, further comprising communicating the generated instruction via a user interface (145).

15. The method (200) of claim 1, wherein the decision made by the machine learning end-system (106) comprises:
classifying the data;
detecting a pattern in the data;
predicting future data based on the transmitted data; and/or
recognizing a pattern in the data.

16. A non-transitory computer readable storage medium, the computer readable storage medium having computer readable code embodied therein, the computer readable code being configured such that, on execution by a suitable computer or processor, the computer or processor is caused to perform a method comprising:
receiving (204) data transmitted from a data source (102) to a machine learning end-system

(106) via a network facility (104), the data transmission being characterized by a network parameter (120);
making (210) a decision with the machine learning end-system (106) using the data;
determining (212) a decision performance metric (134) for the decision;
comparing (214) the decision performance metric (134) to a decision performance specification; and
generating (224) an instruction to adjust the network parameter (120) based on the comparison.

17. An integrated machine learning system (100), the system comprising:
a network facility (104) configured to transmit data from a data source (102) to a machine learning end-system (106), the data transmission being characterized by a network parameter (120); and
the machine learning end-system (106) configured to:
make a decision (132) using the transmitted data;
determine a decision performance metric (134) for the decision (132);
compare (136) the decision performance metric (134) to a decision performance specification; and
generate an instruction (142) to adjust the network parameter (120), based on the comparison (136).

18. The system (100) of claim 17, wherein the network facility (106) is further configured to:
receive the generated instruction (142) from the machine learning end-system (106); and
adjust the network parameter (120) based on the generated instruction (142).

19. The system (100) of claim 17, wherein the machine learning end-system (106) is a cloud-based system.

20. The system (100) of claim 17, wherein the data source (102) generates the data based on environmental information detected by a sensor (143).
